(19) United States
(12) Patent Application Publication
(10) Pub. No.: US 2002/0084544 A1
(43) Pub. Date: Jul. 4, 2002

(54) Process for applying the clamping pressure to the closed mould of an injection-moulding machine

(76) Inventor: Rupert Morwald, Schwertberg (AT)

Correspondence Address: NOTARO & MICHALOS P.C., Empire State Building, Suite 6902, 350 Fifth Avenue, New York, NY, 10118-6985, US

(21) Appl. No.: 09/956,286

(22) Filed: Sep. 19, 2001

(30) Foreign Application Priority Data
Sep. 25, 2000 (AT) A 1617/2000

(51) Int. Cl. B29C 45/80

(52) U.S. Cl. 264/40.5

(57) ABSTRACT

Process for the application of the clamping pressure to the closed mould of an injection-moulding machine using a servomotor acting on a toggle, the build-up of pressure taking place by moving the toggle into its prespecified final position directly after the closing of the mould by a defined rotation of the servomotor, and the moment applied by the servomotor being monitored, and the place of the clamping of the mould and thus the beginning of the build-up of pressure being inferred from the reaching of a set value.

### DESCRIPTION

The invention relates to a process for applying the clamping pressure to the closed mould of an injection-moulding machine using a servomotor acting on a toggle.

In the case of injection-moulding machines with hydraulic drive of the moving platen, the hydraulic pressure is a directly available measure of the clamping pressure. Only in the case of toggle clamp machines with the transmission ratios change greatly precisely in the critical area, it is expedient and usual to determine the applied clamping pressure by measuring the tie bar expansion.

Injection-moulding machines operated with servomotors have the disadvantage that although the current strength approximately corresponds to the generated moment, in general, the additional use of sensors is required for pressure measurement. This even applies when the force is applied using spindles instead of using toggles.

The invention is based on the consideration that at least with injection-moulding machines without tie bars, the expansion of the frame caused by the build-up of pressure is so great that a deformation can be created so precisely that a sufficiently defined clamping pressure results. According to the invention, it is thus provided that the build-up of pressure takes place by moving the toggle into its prespecified final position directly after the closing of the mould by a defined rotation of the servomotor.

In the drawing an injection-moulding machine without tie bars is shown with the help of the function of which the process according to the invention is explained.

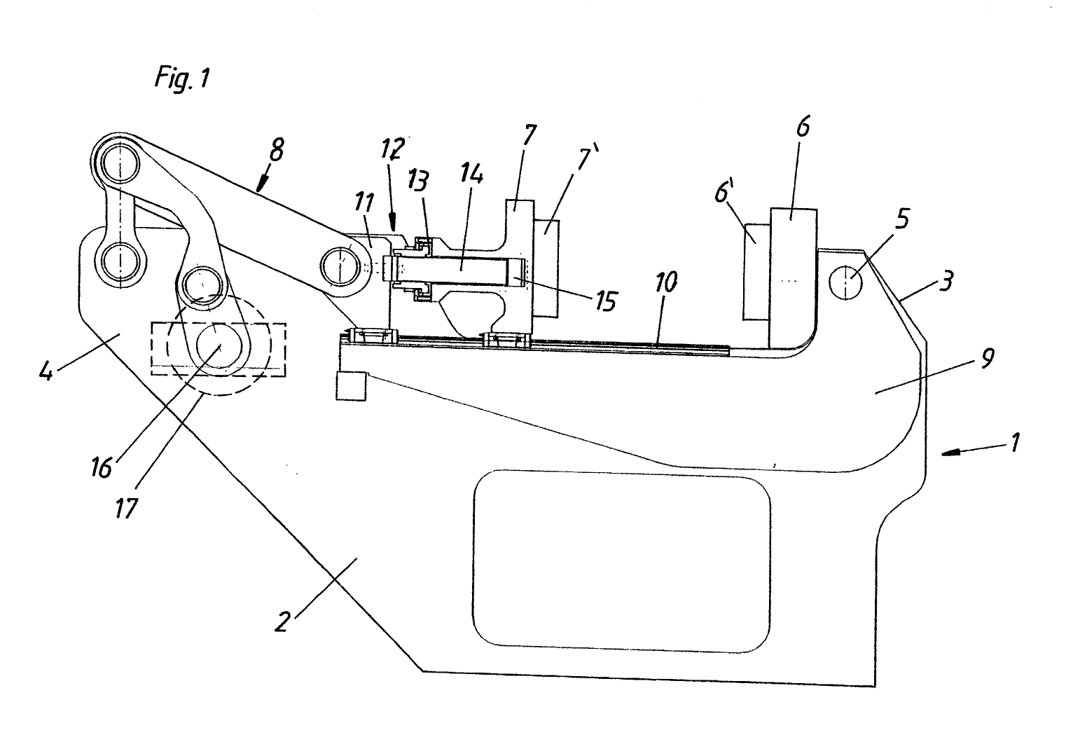

FIG. 1 shows schematically a side view of an injection-moulding machine for carrying out the process.

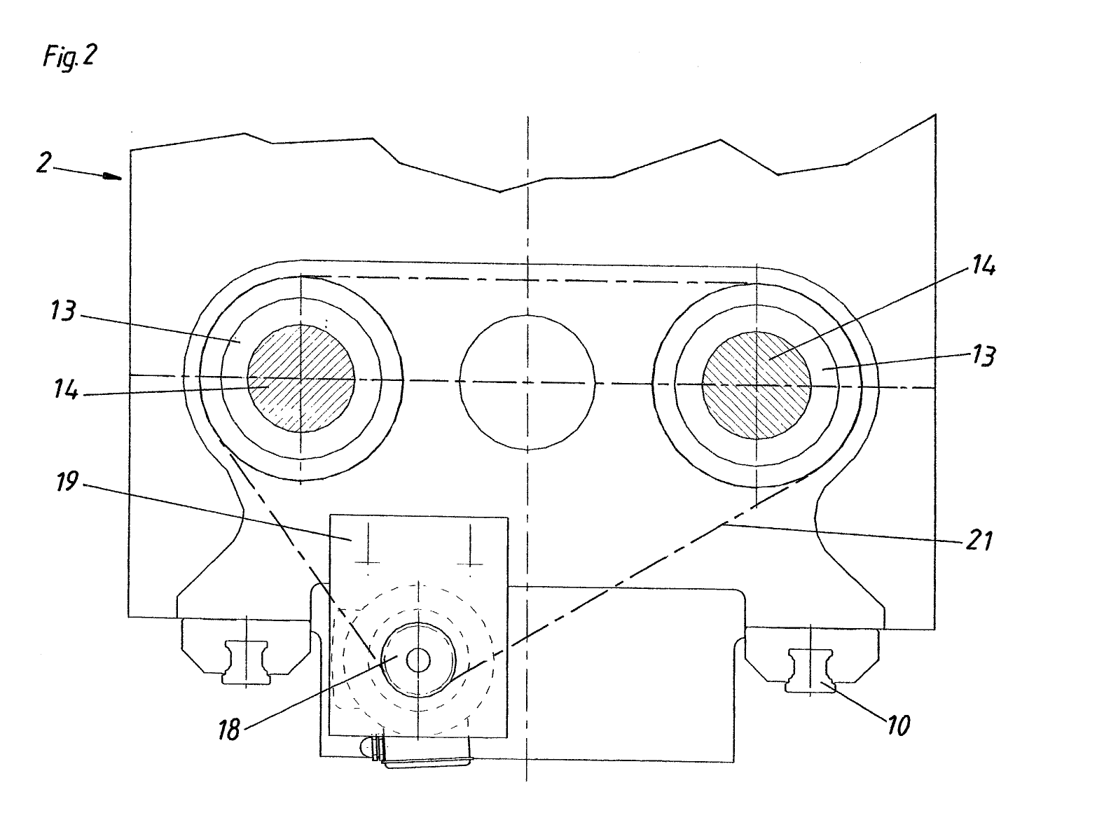

FIG. 2 shows an end-view of the moving platen from FIG. 1, the mould height adjustment mechanism being shown partly in section and

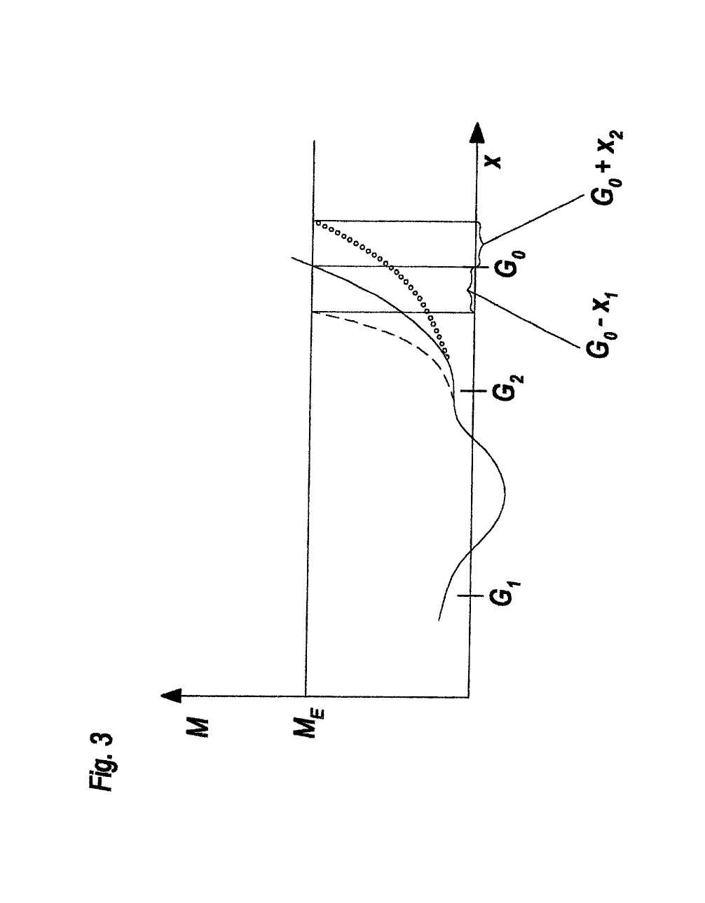

FIG. 3 shows the torque delivered by the servomotor in relation to the position of the platen.

The injection-moulding machine shown in FIG. 1 has an essentially C-shaped frame 1 with a base part 2 and arms 3,4. The stationary platen 6 is arranged on the arm 3 via a hinge 5 and the movable platen 7 is connected to the arm 4 of the C-shaped frame 1 via a clamping mechanism 8. In the embodiment shown, the clamping mechanism 8 is composed of a toggle mechanism combined with a crank assembly. The clamping mechanism 8 forms a part of the clamping apparatus for mould halves 6′, 7′ arranged at the platens 6,7 and is powered by a servomotor 17 acting on the shaft 16 via a corresponding drive.

Likewise housed swivellable about the joint 5 is the L-shaped console 9 which is rigidly connected to the stationary platen 6. The console 9 has guide rails 10 on which the movable platen 7 can be displaced. The L-shaped console 9 thus effects a parallel alignment of the platens 6,7. Because of the articulated connection 5 of the stationary platen 6 to the arm 3 of the frame 1 as well as the articulated connection, effected via the clamping mechanism 8 of the movable platen 7 to the arm 4 of the frame 1, the parallel alignment between the platens 6,7 is also maintained during the application of the clamping force, when the C-shaped frame 1 is elastically deformed and the arms 3,4 are bent up. The arm 4 of the frame 1 serves as front plate.

Such injection-moulding machines without tie bars are adequately known. A further explanation of the details of such an injection-moulding machine is therefore not necessary at this point.

The clamping mechanism 8, i.e. the toggle mechanism combined with a crank assembly does not engage directly with the moving platen 7, but with a pressure pad 11. The pressure pad 11 is able to be moved on the rails 10 on the frame 1 like the moving platen 7.

The moving platen 7 is supported against the pressure pad 11 via the mould height adjustment mechanism 12. The mould height adjustment mechanism 12 includes at least one nut 13, housed rotatable at the moving platen 7, in which at least one spindle 14 attached to the pressure pad 11 engages. The spindle is held non-rotatable at the pressure pad 11 and projects into a cavity 15 of the moving platen 7. At the front end, the spindle 14 is provided with a guide 16 for the spindle 14 in the cavity 15. The guide 16 assumes the form of a journal bearing in the embodiment.

As can be seen from FIG. 2, in the embodiment shown the moving platen 7 is provided with two nuts 13 and two spindles 14. The nuts 13 are driven via V-belts 21 by an electric motor 18 which is preferably constructed as a servomotor. The electric motor 18 is housed at the moving platen 7 via a console 19, below the spindles 14.

To generate a specific clamping pressure in the apparatus shown, the moment M (in practice the current strength) applied by the servomotor 17 is firstly monitored as a function of the position x of the platen 7 from a specified position G₁ (see FIG. 3) which marks the beginning of the mould protection section. The steep rise from G₂ indicates that the mould halves 7′ and 6′ meet here and the build-up of pressure begins.

The invention is based on the consideration that each further displacement of the platen 7 leads to a much greater expansion of the machine frame. The clamping force which is assigned to a specified expansion results from the elasticity constant of this frame by simple calculation. This expansion can be achieved by a defined rotation of the servomotor, provided that this brings the toggle into the same final position each time, so that the same transmission ratios obtain. To be able to fulfil this condition, it is merely necessary to adjust the mould height via the motor 18, as the mould halves 6′, 7′ come into contact at a different position of the clamping mechanism 8 for different mould heights.

Various methods are known to establish the time and/or the position of the mould contact (G₂ in FIG. 3). The establishment of the starting point for the defined rotation of the servomotor effecting the build-up of pressure is particularly simple when this is selected not at position G₂ in FIG. 3, but at position G₀. This is defined in that at this time or at this point, a previously set moment M₆ is reached. This can preferably be the so-called set-up moment which is established while idling and amounts to approximately one tenth of the clamping force. In all further production cycles, the position x of the moving mould plate is measured upon reaching M₆ and compared with the stored position G₀. In the event of deviation from G₀, the mould height is automatically corrected in the following cycle by the measured deviation (G₀-X₁ or G₀+X₂) so that, upon reaching M₆ during the following build-up of clamping force, the position G₀ is reached again and thus agrees with the initial position. Consequently, the same clamping force is always reached even when the mould expands to a different extent because of the effect of heat.

The mould protection can take place in customary manner in the process shown. After reaching point G₁ therefore, a mould protection time can begin after the expiration of which the machine is switched off if it has not yet reached position G₂. In addition, it is possible to switch off the machine in the interval G₁/G₂ if the moment M₆ is exceeded. It is even better to add tolerance intervals on both sides to the curve shown in FIG. 3, as provided for in the European Patent 096183.

1. Process for applying the clamping pressure to the closed mould of an injection-moulding machine using a servomotor acting on a toggle, characterized in that the build-up of pressure takes place by moving the toggle into its prespecified final position directly after the closing of the mould by a defined rotation of the servomotor.

2. Process according to claim 1, characterized in that the moment applied by the servomotor is monitored and in that the time or place of the clamping of the mould and thus the beginning of the build-up of pressure is inferred from the reaching of a set value.

3. Process according to claim 2, characterized in that, by correcting the mould height, changes in the position of the moving mould halves at which the set value of the moment is reached are balanced out.
